(19) United States
(12) Patent Application Publication
(10) Pub. No.: US 2014/0282107 A1
(43) Pub. Date: Sep. 18, 2014

(54) SYSTEM AND METHOD TO INTERACTIVELY COLLABORATE UTILIZING SEGMENTED LAYERS IN A NETWORK ENVIRONMENT

(71) Applicant: Christopher Hobbs, Vancouver (CA)

(72) Inventor: Christopher Hobbs, Vancouver (CA)

(21) Appl. No.: 14/202,758

(22) Filed: Mar. 10, 2014

Related U.S. Application Data
(60) Provisional application No. 61/779,796, filed on Mar. 13, 2013.

(51) Int. Cl. H04L 29/06

(52) U.S. Cl. CPC H04L 65/403
USPC 715/753

(57) ABSTRACT

The present invention provides a system and method to interactively collaborate in a network environment. The system and method comprises software that enables at least two participants to interact in a format whereby a person can present a document, or presentation or other form of media and have the other participants be able to register, mark up, comment on, rectify, review and observe the presentation media and be able to store, observe, and layer any edits including edits of the other participants, for future review.

### CROSS-REFERENCE TO RELATED APPLICATIONS

This application claims benefit under 35 U.S.C. 119(e) to U.S. provisional patent application Ser. No. 61/779796, filed Mar. 13, 2013, which is incorporated herein by reference in its entirety.

### FIELD OF THE INVENTION

The present invention pertains to the field of shared communication and in particular to interaction between parties on computing platforms.

### BACKGROUND

People live and work in collaborative settings and these are becoming increasingly integrated into the digital world where families and workers collaborate in a networked environment. This holds true for interaction in mixed media environments where people are both interacting on a network or across various platforms such as Skype, X-Box and conventional email and these interactions can be in real time, or delayed by the systems performance. Collaborative documentation for instance focuses on recording and tracking edits to documents. Conventional conferencing and gaming tools have made some inroads, but are limiting in how users can collaborate naturally.

Digital learning and business content is being produced, and there are “viewers” to read and edit, but there is little that helps people interact together with their data in a dynamic, real-time way that emulates a natural human experience.

Therefore there is a need for an intuitive, dynamic, emotive shared network experience that would enable communication when coworkers, students, families, friends and other groups of people come together for their many reasons.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An objective of the present invention is to provide a system and method to interactively collaborate in a network environment. In accordance with an aspect of the present invention, there is provided a system and method comprising software that enables the at least two participants to interact in a format whereby a person can present a document, or presentation or other form of media and have the other participants be able to register, mark up, comment on, rectify, review and observe the presentation media and be able to store, observe, and layer any edits including edits of the other participants, for future review.

In accordance with another aspect of the present invention, there is provided a system and method comprising the tracking and storing of each individual participants' contribution throughout the interaction session. Participants are enabled such that they can access the session at a future time or date to refer back to the collaboration and review and observe the individual contributions of each user with the context of the overall collaboration.

### BRIEF DESCRIPTION OF THE FIGURES

FIG. 1 illustrates the participants in the networked collaboration, including those who interact with the media during the real time session and those who interact at a later time.

FIG. 2 illustrates the media in the networked collaboration where it can comprise of digital video, audio, images, websites, documents, and spatial coordinates.

FIG. 3 illustrates how participants interact with the media, where a participant input creates an output portion by means of an application processor configured to process an individual input where the participant can register, rectify, review, observe and otherwise edit the media.

FIG. 4 illustrates the session and consists of a collaboration session, and a secure profile, in some cases enabling a cloud service and log files depending on the layer security that is desired

FIG. 5 illustrates the network architecture consists of one or more computer devices connected within the same subnet or remotely via the Internet and connected by a central server.

FIG. 6 illustrates the high level architecture, where the system consists of a media layer, a network, a plurality of participant action layers with individual application processors and a repository for shared date communication with the plurality of application processors.

### DETAILED DESCRIPTION OF THE INVENTION

### Definitions

The term Collaborating Device means a computer or computing device including but not limited to smart phones, tablets, personal computers and simulated devices that can operate on a variety of operating systems, including but not limited to iOS, OS X, Linux, Android and Microsoft Windows.

The term Repository is used to define the location for storage, often for safety or preservation.

The term Relive is used to define the review, participation at a later time or observation.

The term Participant is used to define an individual, whether real or imaginary that would use a collaborative device in a networked environment

The term Interaction Session is used to define the connection between one or more participants.

The term Layer is used to define the at least one interface layer created by a participant that can be shared. There can be two types of layers, a media layer where the wrapper contains the digital media which may or may not be present, and an action layer which will capture markup, including but not limited to pen, paintbrush, highlighter, stamp, notepad, eraser, laser pointer, and navigation through the content including but not limited to scroll, zoom, rotation, orientation.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides a system that enables at least two participants 100 to interact in a format whereby a first participant 110 can present a document, or presentation or other form of media 200 and have the other participants 120 be able to register, review and observe on the action layer 300 the presentation media and be able to store, observe, and layer the edits of the other participants for future review.

The invention enables the tracking of each individual participants' contribution throughout the interaction session 400. This enables participants at a future date to refer back to the collaboration and review and observer the individual contributions of each user with the context of the overall collaboration.

In one embodiment, the session 400 begins when a participant opens the invention software using their computer. The participant is provided with the option to create a secure profile 410 requiring a username and password that will be synched locally on the device as well as uploaded to a central server. The participant can authenticate against this profile or may choose not to but will not be able to use the cloud service features. These cloud service features 420 include but are not limited to saving a session for later review and remote connectivity to other participants. The initial participant who creates the collaboration session is the presenter. The presenter may or may not decide to make the session private with a password. If the private session has been opted then a password will be required for other participants to join the session. Another security scenario is to create a private group on the central server. If a user is not a member of this group they may not join the collaboration session.

One or more participants may join the session after the authentication process has completed. The participants that do not affect the media layer are called the attendees. At any time a presenter can authorize an attendee to become the presenter. In such a case the original presenter now becomes an attendee or may elect to leave the collaboration session. When an attendee joins the collaboration session 430 the attendee's computer assigns an action layer. This action layer is sent to all other devices connected to the collaboration session. Each action layer is stacked on top of the other participants' action layer or layers which is stacked on top of the media layer.

When the attendee joins the session the media file may or may not be sent to their device. If the media file is sent to each participant's device then the markup actions and the coordinate information is transmitted and presented on each of the other participants' devices. If the media file is not sent to each participants' device then the media layer view is captured as a digital image and that image is sent over the network to each of the attendees' devices. Each time the presenter affects the view of the media layer by taking such actions that include but are not limited to pinch and zoom, scrolling, or rotation this updated image is captured on the presenter's device and sent to and updates all the attendee's devices media layers.

When a collaborative session is complete each device that was part of the collaborative session retains the log files 440 locally. The log files along with any associated media and sound files may or may not be synched with a central server. Through the invention software these files can then be revisited at a future session.

If permission has been granted a presentation that has been synched to the central server may or may not be experienced by parties that attended the original collaborative session. These parties can view each action layer they have been given permission to view. These parties may view the media layer. If permission has been granted these parties may or may not create their own action layer which can be added to the original collaborative session and synched with the server. Once synched all permitted parties may view the new action layer along with the original presentation.

One advantage of the present invention is that it allows a participant or other authorized person to relive the collaboration at a future date and relive the individual contributions as a series of edit layers within the time flow sequence of the collaboration.

The invention is ideally suited to creating simple ad-hoc team collaborative interactions that capture the interaction of the participants and allow a person to subsequently review who made what contribution to the ad-hoc collaboration/discussion.

Collaboration is possible with any tablets in a local network and is also location independent whereby collaboration is provisioned via a repository or cloud-based server, which will also support authentication based on the organizations' directory servers, and encrypted storage of session information. Every action whether on an individual layer or collaborative layer for the at least two participants is recorded and time stamped so that it is possible for someone to completely review or edit the experience at a later time including all audio, video or other media.

One objective of the invention is to enable people to achieve an effective and natural collaborative experience, and then allow them to be relived from the point of view of any participant based on a computer based application that can be modified over time by reviewing and improving upon a already posted interaction.

One preferred embodiment for the computer is a tablet such as an iPad because it is a mobile device freeing up a participant to be mobile while collaborating with the other participants.

The distributed interaction includes a plurality of input and output devices arranged to produce an individual yet shared experience that can be shared in real time across a network. The system consists of a media layer, a network, a plurality of participant action layers with individual application processors and a repository for shared date communication with the plurality of application processors.

Each respective input creates an output portion that is in context with the action layer whereby an application processor is configured to process an individual input to the layer. The action layer repository provides the context information to the plurality of application processors. The architecture includes interface devices including those that can be used in a gaming environment including accelerometers, gyroscopes, compass or simulation of real or imaginary objects and to include individual rich media, including video, audio, or 3D augmented reality inputs.

The invention is a software application that allows the at least two participants to collaborate on top of any digital content. An initial participant, know as the presenter, initiates a presentation on which other devices can connect to. The presenter selects a media file which is then contained within the media layer. The media layer includes but is not limited to a digital video, image, website, document, two dimensional or multidimensional spatial coordinates.

In the absence of media, the media layer will contain a blank canvas. The at least one participant and their individual device can connect to the presentation. This connection can be peer to peer, remote or a combination of peer to peer and remote. The digital content selected by the presenter is then sent to each device as a connection is made. Both the presenter and the other participants have access to separate layers, the action layer, essentially an individual digital canvas that is the width and height of the media layer which sits on top of the media layer. Each device's action layer is stacked on top of each other. Each connected user can only affect (markup or edit) their own action layer. Each connected user can choose to view or hide the other participants' action layers. Action layers can be marked up using a number of tools that include but are not limited to pen, paint brush, highlight, stamp, notepad, eraser, laser pointer or other computer or digital or analog interface or input device. as would be known to one skilled in the art. The mark up from each of these tools can be drawn in multiple colors, thickness and spatial dimensions such as Cartesian coordinates.

The container of both the media layer and of each user's action layer can have its size affected by pinch and zoom actions such as enlarge and shrink and its orientation rotated. Each action is broken down into spatial coordinates, such as start coordinates and stop coordinates, and detail including but not limited to page scrolling, pen markup and highlight markup, and further assigned a time/date stamp. Only the action data is sent between machines. This action data is saved to a log file. When a presentation has ended, all files that made up the presentation including but not limited to media files, log files and any recorded sound files. These can be collected and saved to a repository.

The presentation can be shared in real time or can later be accessed and experienced using the time stamped log files syncing the sound and media files. This allows the presentation to be experienced in the future. During this experience a user can show or hide any action layer or combination of action layers as well as any associated media such as video, mark up or audio. The user can also fast forward or rewind the presentation. If the user has permission, they can edit their own action layer which can then be saved back into the repository to be later re-experienced. It is one objective of the invention to enable a secure environment such that participants can collaborate over a network without unauthorized third parties.

The invention will now be described with reference to specific examples. It will be understood that the following examples are intended to describe embodiments of the invention and are not intended to limit the invention in any way.

### EXAMPLES

### Example 1

A number of participants who are geographically distant from each other want to experience a movie together. Participant #1 is located in one location, and using the invention software creates a profile that is saved on a central server. Participant #1 links her friends to her profile through an invitation via social media and/or email. The system performs a check to see if her friends already have profiles. If they do not an email is sent inviting them to join and download the software to their device. Participant #1 selects the media. The video experience is now ready to be shared.

Participant #2 is located in a geographically distant location. Participant #2 already has a profile on the central server and the invention software app on her device. She opens the software app and is alerted through a list of current presentations that Participant #1 has created a presentation and has given Participant #2 authority to connect. Participant #2 selects Participant #1's presentation. An alert is sent to Participant #1's device stating that Participant #2 has joined. The media file is sent from Participant #1 to Participant #2's device. Participant #1 and Participant #2 can share a voice conversation with each other through the software app.

### Example 2

A teacher is the presenter and is instructing a class for 22 students on an iPad. Each of the 22 students is a participant and is allowed to bring in their own mobile device. 12 students have iPads. 4 students have Android based tablets. 6 students have Windows 8 surface devices. The teacher has been using a PDF document as the media layer for this class as well as the invented software application.

The teacher starts the presentation as a group presentation and only members of the group the teacher had set up are able to see the presentation connection option. All students open the software application on their devices and join the teacher's presentation. The teacher can see from the count of connected users that one student is missing. One participant is at home with a cold. But, since this participant has access to the Internet and their device has the software application installed, they are able to connect remotely. The teacher sees from the count that Student 22 has joined the class from home.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims

We claim:

1. A system and method comprising software that enables the at least two participants to interact in a format whereby a person can present a document, or presentation or other form of media and have the other participants register, mark up, comment on, rectify, review and observe the presentation media and be able to store, observe, and layer any edits including edits of the other participants, for future review

2. The system and method in claim 1, where any participant is able to edit including and where any of the edits form a layer specific to a person or time of the edit.

3. The system and method in claim 1, where any participant is able to edit their action layer, including markup comments, during and after a presentation.

4. The system and method in claim 1, where a person not part of the original presentation can join and interact with a session upon joining a session and are provided their own layer to interact with, whether or not the original session has been completed.

5. A system and method comprising the tracking and storing of each individual participants' contribution throughout the interaction session. Participants are enabled such that they can access the session at a future time or date to refer back to the collaboration and review and observe the individual contributions of each user with the context of the overall collaboration.

6. The system and method in claim 5, where any participant is able to edit their action layer, including markup comments, during and after a presentation.

7. The system and method in claim 5, where a person not part of the original presentation can join and interact with a session upon joining a session and are provided their own layer to interact with, whether or not the original session has been completed.
